(19) United States
(12) Patent Application Publication
(10) Pub. No.: US 2026/0296416 A1
(43) Pub. Date: Oct. 1, 2026

(54) SYSTEMS AND METHODS FOR BEHAVIOR ADAPTATION OF AUTOMATED DRIVING SYSTEMS BASED ON DRIVING STYLES OF SURROUNDING ROAD ACTORS

(71) Applicant: Torc Robotics, Inc., Blacksburg, VA (US)

(72) Inventors: Vicent Rodrigo Marco, Stuttgart (DE); Vahid Samadi Bokharaie, Tuebingen (DE); Filip Zashev, Muenchen (DE)

(21) Appl. No.: 19/094,375

(22) Filed: Mar. 28, 2025

(51) Int. Cl. B60W 30/095; B60W 30/18

(52) U.S. Cl. CPC B60W 30/0956; B60W 30/18163; B60W 2552/10; B60W 2554/4045; B60W 2554/4046; B60W 2554/4049; B60W 2554/406; B60W 2554/80; B60W 2555/20; B60W 2720/10

(57) ABSTRACT

A system for monitoring driving styles of road actors in the surrounding of a vehicle can include one or more sensors of the vehicle to detect and track the road actors in the surrounding of the vehicle and a processing device in communication with the one or more sensors. The processing device can be configured to execute instructions stored in a memory to perform operations comprising receiving, from the one or more sensors, sensor data indicative of kinematic parameters of the road actors, determining, using the sensor data, relative kinematic parameters of a road actor relative to other road actors and relative to one or more road features, determining, using the kinematic parameters and the relative kinematic parameters of the first actor, a driving style of the road actor and determining one or more actions to be taken by the vehicle based on the driving style.

### TECHNICAL FIELD

The field of the disclosure relates to monitoring road actors and identifying driving styles. In particular the field of the disclosure relates to behavior adaptation of automated driving systems based on the identification of driving styles of neighboring road actors.

### BACKGROUND

Modern vehicles, and in particular autonomous and semi-autonomous vehicles, include a variety of sensors to perceive their surroundings. The sensors are critical components especially for autonomous and semi-autonomous vehicles, because they act as the “eyes” and “ears” of the corresponding vehicles. In particular, the sensors provide via respective sensing techniques various perceptions of the surroundings or environment of the vehicle to enable various driver-assistance features and/or self-driving features. Sensors installed in a modern vehicle constantly monitor a multitude of parameters of the vehicle and its surroundings. Such parameters can include, e.g., engine temperature, oil pressure, tire pressure, vehicle speed, as well as the speed, distance, and relative position of objects around the vehicle. Sensor data collected by the vehicle sensors is typically fed or provided to one or more processing devices or units, such as the electronic control unit (ECU), which can be used to make real-time adjustments or decisions related to various systems of the vehicle.

With advancements in sensing technology and artificial intelligence, modern vehicles are equipped with a wide array of sensors to enable advanced driver-assistance systems (ADASs) and/or automated driving systems (ADSs). To make decisions, the systems rely mainly on sensor data provided by the sensors onboard the vehicle. The ADS uses the sensor data to maintain a safe driving behavior. However, even if the ADS maintains a safe driving behavior, road actors around an ego vehicle may exhibit unsafe, risky and/or dangerous driving behaviors putting the ego vehicle and any passengers therein at risk. Therefore, one of the technical challenges faced by ADASs and ADSs is how to reliably detect road actors exhibiting unsafe, risky and/or dangerous behaviors, and take proper actions to mitigate or avoid any risk.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an example system for monitoring road actors is provided. The system can include one or more sensors of a vehicle to detect and track a plurality of actors in a surrounding of the vehicle and a processing device in communication with the one or more sensors. The processing device can be configured to execute instructions stored in a memory to perform operations comprising receiving, from the one or more sensors, sensor data indicative of kinematic parameters of the plurality of actors, determining, using the sensor data, relative kinematic parameters of a first actor of the plurality of actors relative to other actors and relative to one or more road features, determining, using the kinematic parameters and the relative kinematic parameters of the first actor, a driving style of the first actor and determining one or more actions to be taken by the vehicle based on the driving style of the first actor.

In another aspect, an example method for monitoring road actors provided. The method can include receiving, from one or more sensors of a vehicle, sensor data indicative of kinematic parameters of a plurality of actors in a surrounding of the vehicle, determining, using the sensor data, relative kinematic parameters of a first actor of the plurality of actors relative to other actors and relative to one or more road features, determining, using the kinematic parameters and the relative kinematic parameters of the first actor, a driving style of the first actor; and determining one or more actions to be taken by the vehicle based on the driving style of the first actor.

In yet another aspect, a non-transitory computer-readable medium including software instructions for monitoring road actors stored thereon is provided. The software instructions when executed by one or more processors can cause the one or more processors to receive, from the one or more sensors, sensor data indicative of kinematic parameters of the plurality of actors, determine, using the sensor data, relative kinematic parameters of a first actor of the plurality of actors relative to other actors and relative to one or more road features, determine, using the kinematic parameters and the relative kinematic parameters of the first actor, a driving style of the first actor and determine one or more actions to be taken by the vehicle based on the driving style of the first actor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a diagram of a road environment including an ego vehicle monitoring surrounding road actors, according to example embodiment of the current disclosure.

FIG. 7 is a flowchart of a method for monitoring driving styles of surrounding road actors, according to an example embodiment of the current disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

On public roads, vehicles and/or road actors typically exhibit a wide spectrum of driving styles or driving behaviors including passive driving, defensive driving, assertive driving, aggressive driving, angry driving, careless and/or reckless driving, distracted driving, impatient driving behavior, tailgating and/or general dangerous driving. Unsafe driving behaviors not only endanger those exhibiting such behaviors, but also pose a risk to other road users or road actors. For human drivers, the ability to identify unsafe or dangerous driving behaviors and taking proper actions is crucial for maintaining road safety. Experienced drivers can timely recognize unsafe driving behaviors, anticipate the potential risks and become more vigilant. For example, a driver can become alert and prepared to react to another driver exhibiting reckless or erratic behavior, maintain a larger follow distance or change lanes upon recognizing a tailgater, reduce speed and keep a safe distance from an aggressive driver are typical strategies employed by experienced drivers. By understanding these behavior patterns, drivers can predict potentially dangerous situations and take preventive measures. As used herein, road actors can include pedestrians, animals, non-motorized vehicles, e.g., bicycles, and/or motorized vehicles, such as trucks, cars, buses and/or motorcycles among other types of motorized vehicles.

Automated driving systems (ADSs) rely on data from a wide variety of sensors, such as radar sensors, light detection and ranging (LiDAR) sensors, acoustic sensors and/or cameras, to perceive the environment and interpret complex driving scenarios. These systems predict where other vehicles will be based on their current motion state, among other factors. By anticipating trajectories, the ADS can take a proactive approach to conceive safe driving paths.

One technical challenge faced by ADSs is how to detect road actors with unsafe, risky or dangerous driving styles, and determine the proper action(s) to be taken to avoid or stay away from such road actors. Addressing this technical challenge or problem leads to enhancing the reliability and safety of ADSs enabling them to identify and respond to various driving behaviors in an effective and proactive manner.

Embodiments described herein enable reliable estimation of the driving styles of road actors in the surroundings of an ego vehicle. A novel approach to identify and handle unsafe driving styles is introduced. The driving style of a road actor in the surrounding of the ego vehicle can be determined using kinematic parameters of the road actor as well as relative kinematic parameters of the road actor with respect to other road actors and road features. One or more actions to be taken by the ego vehicle can be determined based on the driving styles of the road actors surrounding the ego vehicle. The relative positions of the road actors with respect to the ego vehicle can also be used to determine the proper action(s) to be taken by the ego vehicle.

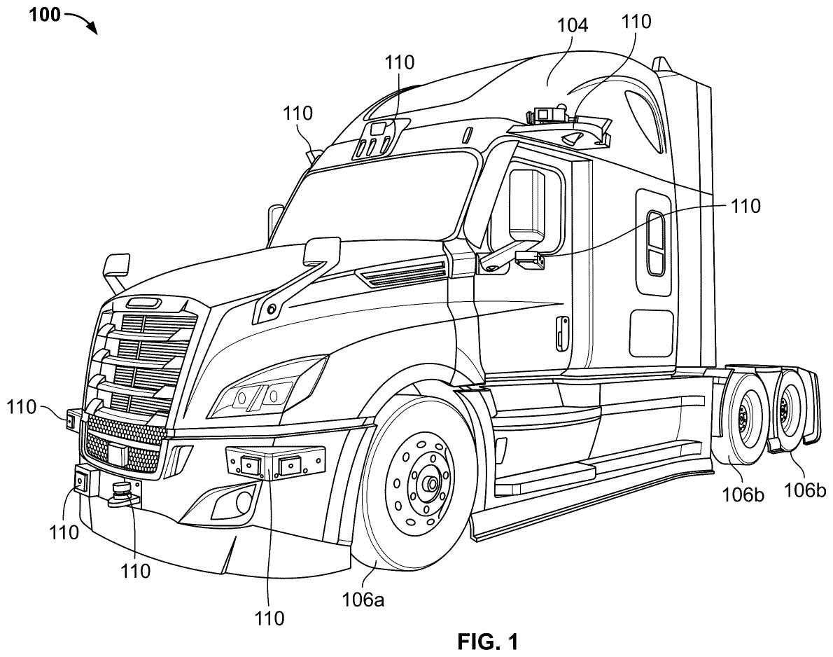

Various embodiments in the present disclosure are described with reference to FIGS. 1-7 below.

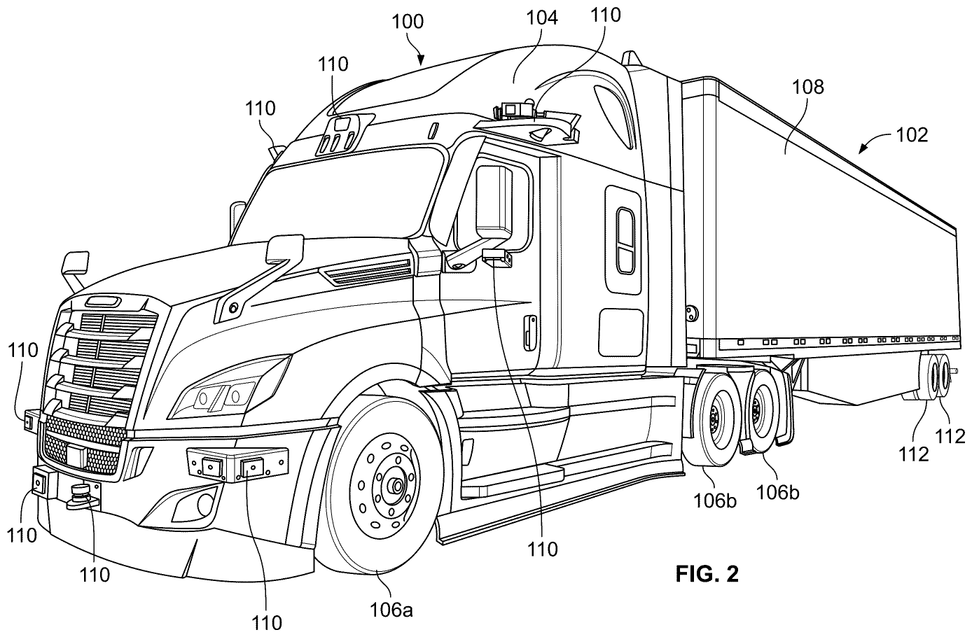

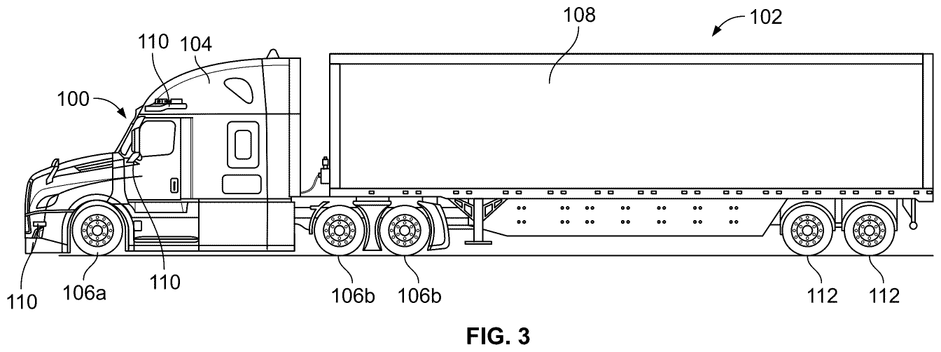

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

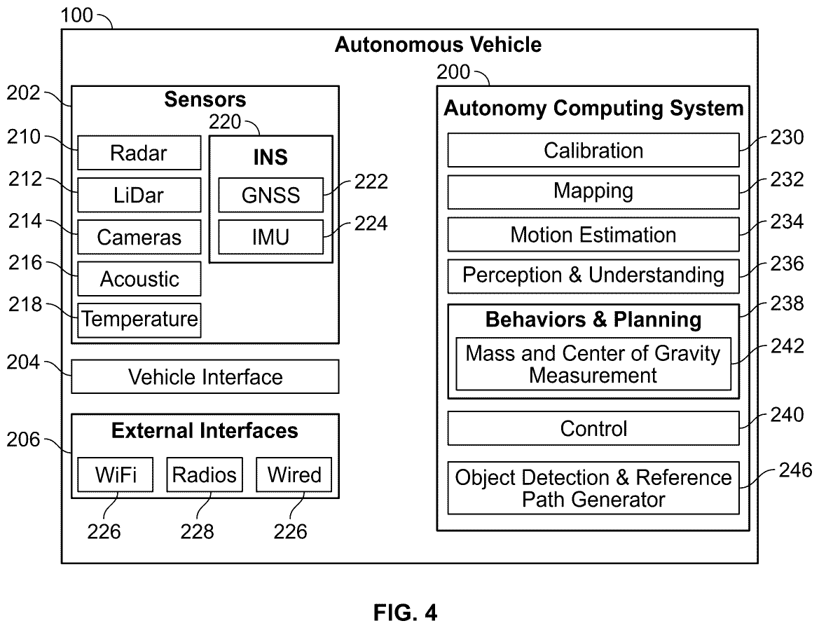

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify objects, such as one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motion characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

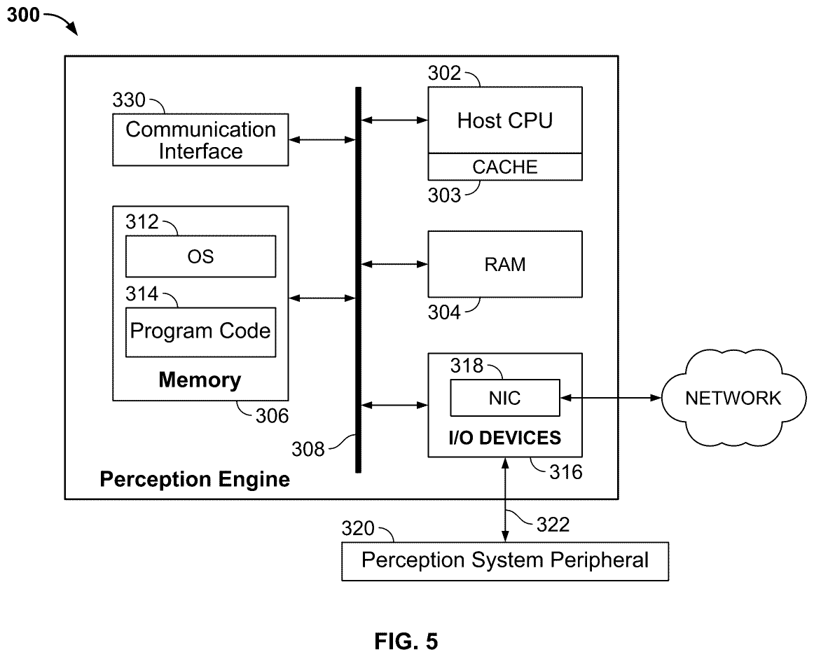

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors 214, one or more cameras 214, or a CAN bus controller for communicating over a CAN bus.

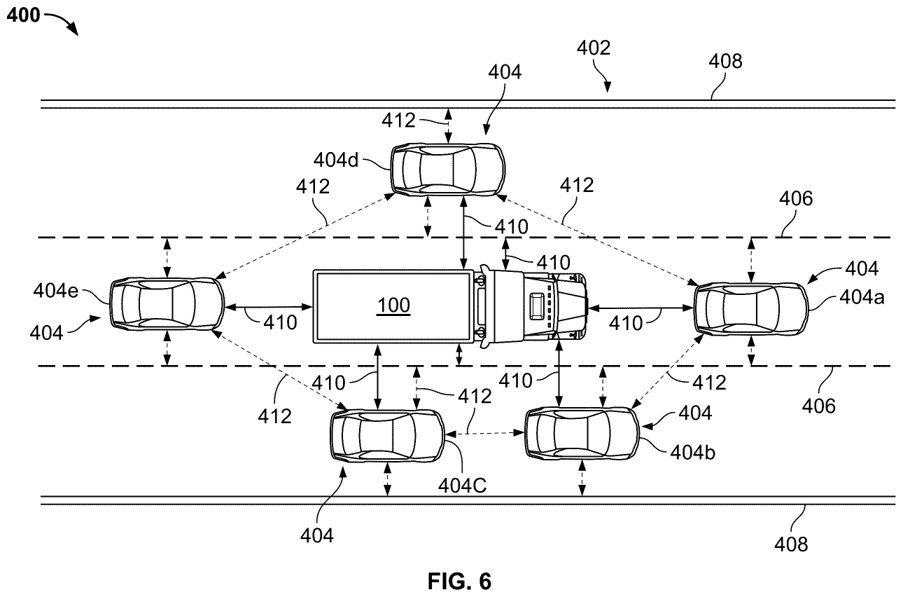

FIG. 6 is a diagram of a road environment 400 including an ego vehicle 100 monitoring road actors 404 in its surrounding while driving on a road 402, according to example embodiment of the current disclosure. As described above in relation to FIG. 1-5, the ego vehicle 100 can include a plurality of perception sensors 202, such as radar sensor(s) 210, LiDAR sensor(s) 212, camera(s) 214, acoustic sensor(s) 216 GNSS receiver 222 and/or IMU(s) 224 among possibly other types of sensors to perceive the surrounding of the ego vehicle 100 and detect objects or road actors in the surrounding of the ego vehicle 100. The sensors 202 can provide or can be used to determine or estimate the kinematic states of the road actors 404 surrounding the ego vehicle 100. The kinematic states can include kinematic parameters, such as positions (or relative positions with respect to the ego vehicle 100) velocities, turning or yaw rates and/or accelerations. The ego vehicle 100 can monitor, e.g., while driving on the road 402, behaviors and/or driving styles of the road actors 404 perceived by the sensors 202 of the ego vehicle 100. The ego vehicle 100 can adapt its behavior or adjust its driving decisions based on the determined behaviors or driving styles of the road actors 404 in the surrounding of the ego vehicle 100.

Embodiments described herein address the detection and identification of different driving styles for road actors surrounding the ego vehicle 100 controlled by the autonomy computing system 200. The autonomy computing system 200 can adjust the behavior(s) of the ego vehicle 100 in response to the driving styles of the road actors in the proximity of the ego vehicle 100 to enhance the overall safety of the ego vehicle 100.

While FIG. 6 depicts the road actors 404 as cars driving in the vicinity of ego vehicle 100, in general, the road actors 404 can include any type of road vehicles, e.g., cars, trucks, motorcycles, bicycles, etc., farm trucks, trains at railroad crossings, pedestrians and/or animals, among possibly other types of road actors. Also, FIG. 6 shows five road actors 404a-404e in the surrounding of ego vehicle 100 as an illustrative example. In general, any number of road actors can be in the surrounding of ego vehicle 100. Furthermore, the extent of the surrounding perceived by the sensors 202 of the ego vehicle 100 or the field view (FOV) of the ego vehicle 100 can depend on the number, locations and perception ranges of the sensors 202.

Each radar sensor 210 can output a respective point cloud representing a three-dimensional (3D) map of the portion of the environment or surrounding of ego vehicle 100 that is within the FOV of the radar sensor 210. Also, each LiDAR sensor 212 can output or provide a respective point cloud representing a three-dimensional (3D) map of the portion of the environment or surrounding of vehicle 100 that is within the FOV of the LiDAR sensor 212. Each point in the point clouds provided by the radar sensor(s) 210 or the LiDAR sensor(s) 212 is associated with a detected object in the surrounding of the ego vehicle 100. Each road actor 404 (404a-404e in FIG. 6) in the FOV of a radar sensor 210 or a LiDAR sensor 212 can be represented as a set of points in the point cloud generated by the sensor. Each radar sensor 210 and each LiDAR sensor 212 can provide the kinematic states of various points of the vehicle represented in the respective point cloud. The kinematic states of a point in the point cloud can include the point's coordinates, the point's velocity and/or the point's acceleration, e.g., relative to the ego vehicle 100 or the corresponding sensor. Each camera 214 can capture one or more images, or a video sequence, of the vehicle surrounding from a view angle defined by the position, orientation and/or FOV of the camera 214. The radar sensors 210, LiDAR sensors 212 and/or cameras 214 can be arranged at different positions in the ego vehicle 100, and can have different orientations, different FOVs and/or different perception ranges.

The GNSS receiver 222 can provide geolocation of the ego vehicle 100. However, the accuracy of the position data provided by the GNSS receiver 222 can range from two to ten meters. The IMU 224 can measure kinematic parameters of the ego vehicle 100, such as velocity, yaw turning rate and/or acceleration.

The autonomy computing system 200 or the perception and understanding module 236 can continuously or periodically receive sensor data from the sensors 202 while the ego vehicle 100 is driving on the road 402. The autonomy computing system 200 or the perception and understanding module 236 can use the sensor data to determine and/or continuously monitor the kinematic states of the ego vehicle 100 and the kinematic states of the road actors 404 perceived in the surroundings of the ego vehicle 100. The continuous-line double arrows 410 in FIG. 6 represent the kinematic states of the ego vehicle 100 and the road actors 404a 404e. The kinematic state of the ego vehicle 100 can include the relative positions of the lane lines 406 and/or road line(s) 408 relative to the ego vehicle 100 or the position of the ego vehicle 100 relative to the lane lines 406 and/or road line(s) 408. The kinematic states of each road actor 404 can include the position, velocity, yaw turning rate and/or acceleration of the road actor 404, e.g., relative to the ego vehicle 100.

The autonomy computing system 200 or the perception and understanding module 236 can estimate or determine, for each road actor 404, relative kinematic state of the road actor 404 with respect to other actors 404 and/or road features, using the kinematic states of the road actors 404. In FIG. 6, the dashed-line double arrows 412 represent the relative kinematic states or parameters of the road actors 404. For example, for vehicle 404a, the relative kinematic state can include the position, velocity and/or acceleration of the vehicle 404a relative to the vehicles 404b and 404d, which are in the immediate vicinity of vehicle 404a. The relative kinematic state of vehicle 404a can include the position of the vehicle 404a relative to the lane lines 406 and/or road line(s) 408. The relative kinematic state for vehicle 404b can include the position, velocity and/or acceleration of the vehicle 404b with respect to the vehicles 404a and 404c as well as the relative position of the vehicle 404b with respect to the lane lines 406 and/or road line(s) 408. The relative kinematic state for vehicle 404c can include the position, velocity and/or acceleration of the vehicle 404c with respect to the vehicles 404b and 404d as well as the relative position of the vehicle 404c with respect to the lane line(s) 406 and/or road line(s) 408. The relative kinematic state for vehicle 404d can include the position, velocity and/or acceleration of the vehicle 404d with respect to the vehicles 404a and 404e as well as the relative position of the vehicle 404d with respect to the lane line(s) 406 and/or road line(s) 408. The relative kinematic state for vehicle 404e can include the position, velocity and/or acceleration of the vehicle 404d with respect to the vehicles 404c and 404d as well as the relative position of the vehicle 404e with respect to the lane lines 406.

The autonomy computing system 200 and/or the behaviors and planning module 238 can use the kinematic states and the relative kinematic states of the road actors 404 to determine or detect behaviors and/or driving styles of the road actors in the surround of ego vehicle 100. Multi-object tracking techniques commonly leverage information from the perception sensors 202, e.g., radar sensors 210, LiDAR sensors 212 and/or cameras 214, to detect and track multiple road actors 404 during the time period when road actors 404 are in the vicinity of the ego vehicle 100. The sensor data is typically used to determine or estimate the kinematic states or kinematic parameters of the road actors 404 in the surrounding of the ego vehicle 100, and deduce or infer from the kinematic states the driving style of each road actor in the surrounding of the go vehicle 100. However, a more accurate and more comprehensive assessment of the driving style of each road actor should also take into account the relative kinematic states or relative kinematic parameters of each road actor 404 with respect to other road actors 404. For example, any of road actors 404a-404d, which are not behind the ego vehicle 100, may be tailgating another vehicle ahead of it. Such tailgating behavior may not be detected based on the kinematic state or kinematic parameters of the road actor 404 but would be detected by the ego vehicle 100 if the relative kinematic state or relative kinematic parameters of the road actor 404 with respect to other road actors 404 are taken into consideration. Also, any of the road actors 404b-404d may exhibit delayed braking relative to another vehicle ahead of it. Such driving behavior may not be detected based on the kinematic state or kinematic parameters of the road actor 404 but would be detected by the ego vehicle 100 if the relative kinematic state or relative kinematic parameters of the road actor 404 with respect to other road actors 404 are taken into consideration.

The autonomy computing system 200 and/or the behaviors and planning module 238 can adjust the behavior or driving decisions of ego vehicle 100 based on the determined behaviors or driving styles of the road actors 404. For example, the autonomy computing system 200 and/or the behaviors and planning module 238 can take proper actions or decisions to keep the ego vehicle 100 away from any road actor 404 exhibiting dangerous or reckless driving style.

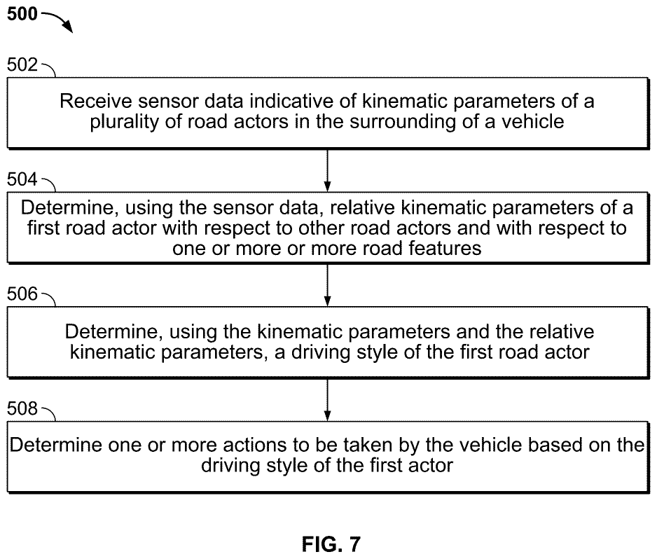

FIG. 7 is a flowchart of a method 500 for monitoring road actors 404, according to an example embodiment of the current disclosure. In brief overview, the method 500 can include, at 502, receiving sensor data indicative of kinematic parameters of a plurality of road actors in the surrounding of ego vehicle 100, determining, at 504, using the sensor data, relative kinematic parameters of a road actor with respect to other road actors and with respect to one or more road features, determining, at 506, a driving style of the road actor using the kinematic parameters and the relative kinematic parameters, and determining, at 508, one or more actions to be taken by the ego vehicle 100 based on the driving style of the first road actor. The method 500 can be implemented, executed or performed by the processor 302, the autonomy computing system 200, the perception and understanding module 236 and/or the behaviors and planning module 238.

The method 500 can include, at 502, the autonomy computing system 200 and/or the behaviors and planning module 238 receiving sensor data indicative of kinematic parameters of a plurality of road actors in the surrounding of ego vehicle 100. The autonomy computing system 200 and/or the behaviors and planning module 238 can continuously or periodically receive sensor data from the sensors 202 while the ego vehicle 100 is driving. In some implementations, the radar sensor(s) 210, LiDAR sensor(s) and/or camera(s) 214 can be positioned in or on the vehicle 100 to provide a 360 degrees FOV. The perception and understanding module 236 can analyze the sensor data to detect and/or distinguish between separate road actors 404 in the surrounding of the ego vehicle 100. The perception and understanding module 236 can extract or determine the kinematic state or kinematic parameters for each road actor 404 from the received sensor data. For example, the perception and understanding module 236 can determine, for each perceived road actor 404, the respective position, velocity, yaw turning rate and/or acceleration (e.g., relative to the ego vehicle 100) using point cloud(s) and/or kinematic parameter measurements obtained from the radar sensor(s) 210, LiDAR sensor(s) 212 and/or acoustic sensor(s) 216.

In some implementations, the autonomy computing system 200 and/or the perception and understanding module 236 can use images captured by the camera(s) 214 to identify and/or distinguish between separate road actors. For example, the perception and understanding module 236 can extract and/or determine, for each vehicle 404 in the surroundings of ego vehicle 100, the corresponding vehicle license plate number from images captured by the camera(s) 214. In some implementations, the autonomy computing system 200 and/or the perception and understanding module 236 can employ object recognition algorithms to distinguish between different road actors, such as pedestrians, animals, motorized vehicles and non-motorized vehicles. In some implementations, at least some of the vehicles in the surroundings of the ego vehicle 100 can communicate their identifiers to the ego vehicle 100, e.g., via vehicle-to-vehicle (V2V) wireless communications and/or vehicle-to-everything

### (V2x) Wireless Communication.

The autonomy computing system 200 and/or the perception and understanding module 236 can keep track of the kinematic state or kinematic parameters of a road actor 404 over time while the road actor 404 is still in the surroundings of the ego vehicle 100 and perceived or sensed by the sensors 202 of the ego vehicle 100. For example, the autonomy computing system 200 and/or the perception and understanding module 236 can keep recording and/or maintaining kinematic parameters of road actor 404a for the time period during which the road actor 404a is in the surrounding of the ego vehicle 100 and perceived or sensed by the sensors 202. The same is true for every other road actor, such as road actors 404b-404e. The autonomy computing system 200 and/or the perception and understanding module 236 can maintain data associated with a road actor 400 for a defined time duration after the road actor 404 leaves the surrounding of the ego vehicle 100 and is no more perceived or sensed by the sensors 202.

The autonomy computing system 200 and/or the perception and understanding module 236 can also determine kinematic parameters of the ego vehicle 100, such as velocity, yaw turning rate and/or acceleration, based on measurements provided by the IMU 224. The autonomy computing system 200 and/or the perception and understanding module 236 can use the velocity of the ego vehicle 100 and the relative velocity of a road actor 404 with respect to the ego vehicle 100, e.g., measured by the radar sensor(s) 210 and/or LiDAR sensor(s) 212, to determine the actual velocity of the road actor 404. The autonomy computing system 200 and/or the perception and understanding module 236 can use the acceleration of the ego vehicle 100 and the relative acceleration of the road actor 404 with respect to the ego vehicle 100, e.g., measured by the radar sensor(s) 210 and/or LiDAR sensor(s) 212, to determine the actual acceleration of the road actor 404.

The method 500 can include, at 504, the autonomy computing system 200 and/or the behaviors and planning module 238 determining using the sensor data, relative kinematic parameters of an actor 404 with respect to other road actors 404 and with respect to one or more road features. The relative kinematic parameters of a road actor 404 can include at least one of a relative velocity of the road actor 404 compared to the velocity of another road actor 404, a relative acceleration of the road actor 404 compared to the acceleration of the other road actor 404, a relative position of the road actor with respect to the other road actor 404, or a relative position of the road actor 404 with respect to one or more road features, such as lane line(s) 406 and/or road line(s) 408. The kinematic parameters of each road actor 404 as well as the respective relative kinematic parameters with respect to other road actors 404 and/or road features can be indicative of the driving style of the road actor 404.

As used herein, road features can include lane lines 406, road lines 408, pedestrian crosswalks, sidewalks, bike paths, road shoulders, road signs, traffic lights and/or objects on the side of the road 402. The autonomy computing system 200 and/or the behaviors and planning module 238 can detect the road features and their positions using the sensor data, e.g., received from the radar sensor(s) 210, LiDAR sensor(s) 212 and/or acoustic sensor(s) 216. The autonomy computing system 200 and/or the behaviors and planning module 238 can use the kinematic parameters of each road actor 404 and the positions of the road features to determine the relative position of the road actor 404 with respect to one or more road features. For example, as depicted in FIG. 6 via some of the dashed-line double arrows 412, the autonomy computing system 200 and/or the behaviors and planning module 238 can store and track the varying relative position of each of the road actors 404b, 404c and 404d, which are on the rightmost lane or leftmost lane, with respect to the lane line 406 and the road line 408 defining the lane in which the road actor is driving. The autonomy computing system 200 and/or the behaviors and planning module 238 can keep track of the varying relative position of each of the road actors 404a and 404e with respect to the lane lines 406 defining the middle lane.

The autonomy computing system 200 and/or the behaviors and planning module 238 can determine, for each of the road actors 404a-404e, the relative kinematic parameters of the road actor 404 with respect to other road actors 404, using the kinematic parameters of the road actors 404a-404e. For example, the autonomy computing system 200 and/or the behaviors and planning module 238 can use the positions, velocities and/or accelerations of the road actors 404b and 404c to determine the relative position, relative velocity and/or relative acceleration of road actor 404c with respect to road actor 404b. In particular, the autonomy computing system 200 and/or the behaviors and planning module 238 can subtract the coordinates of road actor 404c from the coordinates of road actor 404b to determine the relative position of road actor 404c with respect to road actor 404b, subtract the velocity of road actor 404c from the velocity of road actor 404b to determine the relative velocity of road actor 404c with respect to road actor 404b, and/or or subtract the acceleration of road actor 404c from the acceleration of road actor 404b to determine the relative acceleration of road actor 404c with respect to road actor 404b. That is, the autonomy computing system 200 and/or the behaviors and planning module 238 can subtract the kinematic parameters of a first road actor 404 (e.g., at some time instance) from the kinematic parameters of a second road actor 404 (e.g., at substantially the same time instance) to determine the relative kinematic parameters of the first road actor 404 with respect to the second road actor 404.

The autonomy computing system 200 and/or the behaviors and planning module 238 can keep track, for each road actor 404 in the surroundings of the ego vehicle 100, of the respective relative kinematic state or relative kinematic parameters with respect to other road actors 404 and/or road features while the road actor 404 is within the surrounding of ego vehicle 100. For example, while road actor 404a is in the surroundings of ego vehicle 100, the autonomy computing system 200 and/or the behaviors and planning module 238 can continuously or periodically determine the relative kinematic parameters of road actor 404a with respect to at least one of the other road actors 404b-404e and/or with respect to one or more road features. In other words, the assessment of the relative kinematic parameters of each of the road actors 404a-404e can continue repetitively over time while the road actor is still within the FOV of the sensors 202 of the ego vehicle 100.

In some implementations, the autonomy computing system 200 and/or the behaviors and planning module 238 can use the sensor data received from the perception sensors 202 of the ego vehicle 100 to detect and read road signs. For example, the autonomy computing system 200 and/or the behaviors and planning module 238 can process images captured by the camera(s) 214 to identify and/or recognize any road signs depicted therein. The autonomy computing system 200 and/or the behaviors and planning module 238 can use object recognition algorithms to recognize and/or distinguish between different road signs. The autonomy computing system 200 and/or the behaviors and planning module 238 can map each detected road sign to a corresponding traffic rule or regulation. The autonomy computing system 200 and/or the behaviors and planning module 238 can maintain or can have access to one or more data structures, e.g., table(s), that map each possible road sign to the corresponding traffic rule or regulation.

The autonomy computing system 200 and/or the behaviors and planning module 238 can use the sensor data received from the perception sensors 202 of the ego vehicle 100 to detect traffic lights and their state. The autonomy computing system 200 and/or the behaviors and planning module 238 can use images captured by the camera(s) 214 and/or LiDAR point cloud(s) to detect or identify traffic lights and determine the respective state, e.g., red, orange or green.

The method 500 can include, at 506, the autonomy computing system 200 and/or the behaviors and planning module 238 determining a driving style of the first road actor using the kinematic parameters and the relative kinematic parameters. The autonomy computing system 200 and/or the behaviors and planning module 238 can include a driving-style estimator configured to determine or infer the driving style of each road actor 404 in the surrounding of the ego vehicle 100 using at least the kinematic state and the relative kinematic parameters of the road actor 404. As discussed in further detail below, the driving-style estimator can be implemented using a numerical approach, a classifier and/or a trained machine learning model. In addition to the kinematic state and the relative kinematic parameters of each road actor, the driving-style estimator can receive other data as input, such as data related to road signs and/or traffic lights and/or weather data.

The autonomy computing system 200 and/or the behaviors and planning module 238 can repeat determining the kinematic parameters and relative kinematic parameters of each road actor 404 over a time period, and determine the driving style of each road actor 404 using the kinematic parameters and relative kinematic parameters of the road actor 404 determined over the time period. More specifically, for a given road actor 404, the autonomy computing system 200 and/or the behaviors and planning module 238 can determine multiple kinematic states and multiple relative kinematic states associated with multiple time instances with a time period, and estimate a driving style of the road actor 404 using the multiple kinematic states and multiple relative kinematic states of the road actor 404. The use of multiple sets of kinematic parameters and sets of relative kinematic parameters determined over a time period allows for a reliable assessment or determination of the driving style of the road actor 404. The time period can be of a defined or specified duration. Also, the autonomy computing system 200 and/or the behaviors and planning module 238 can repeat determining or estimating the driving style of the road actor 404 while the road actor 404 is still within the surrounding perceived by the sensors 202 of the ego vehicle 100.

In some implementations, the autonomy computing system 200 and/or the behaviors and planning module 238 can compute or determine a plurality of metrics indicative of driving behaviors of the road actor 404, using the kinematic parameters and relative kinematic parameters of the road actor determined over the time period. For example, the autonomy computing system 200 and/or the behaviors and planning module 238 can determine or generate a driving-metrics vector of the road actor 404 using the kinematic parameters and relative kinematic parameters of the road actor determined over the time period. The driving-metrics vector can be referred to as the driving profile of the road actor 404. The autonomy computing system 200 and/or the behaviors and planning module 238 can determine the driving style of the road actor 404 using the plurality of metrics or the driving-metrics vector. For example, the driving-metrics vector can be fed as input to the driving-style estimator.

The driving metrics can be indicative of how well the road actor 404 adheres to driving rules or regulations and/or safe driving practices. The driving metrics can include at least one of an average distance maintained by the road actor 404 relative to a respective front actor, average distance maintained relative to lateral actors, average jerk (time-derivative of the acceleration), average delay in deceleration response, violation of speed limit(s), hard brake maneuvers when there is no other object immediately in front of the road actor 404, an indicator or a number of instances of ignoring road signs (e.g., no turn on red sign, stop sign, no overtaking sign, no U-turn sign, etc.), an indicator or a number of instances of changing lanes or turning without using light indicators, an indicator or a number of instances of crossing lane lines 406 (e.g., swirling driving), an indicator of or a number of instances of running red lights or an indicator or a number of instances of unjustified velocity variations among other metrics indicative of adherence to traffic rules or regulations and/or safe driving practices. The driving metrics can include one or more indicator metrics, e.g., binary indicators, indicating whether some traffic rule has been violated or more generally whether some specific driving behavior has occurred. For example, a first indicator metric can indicate whether the road actor 404 ran a red light and/or a second indicator can indicate whether the road actor 404 did not follow the instructions on one or more road signs. The driving metrics can include one or more metrics indicative of a number of times or a frequency of a some driving behavior, such as a number or frequency of lane crossing, or a number or frequency of violating speed limit.

The autonomy computing system 200 and/or the behaviors and planning module 238 can compute or determine some of the driving metrics, e.g., metrics related to speed limit violation, average jerk and running light, using the kinematic parameters of the road actor 404. Some other driving metrics, such as average distance maintained by the road actor 404 relative to a respective front actor, average distance maintained relative to lateral actors and average delay in deceleration response can be determined or computed using relative kinematic parameters of the road actor 404 with respect to other road actor 404. For example, recorded or measured values of the distance between road actors 404b and 404c can be used to compute the average distance maintained by the road actor 404c relative to the respective front road actor 404b, and measurements of accelerations of the road actors 404b and 404c can be used to determine or compute a delay in deceleration response. The autonomy computing system 200 and/or the behaviors and planning module 238 can use detected road signs together with the kinematic parameters of the road actor 404 to determine whether the road actor 404 failed to follow instructions on any of the road signs. The autonomy computing system 200 and/or the behaviors and planning module 238 can use relative kinematic parameters of the road actor 404 with respect to road features to compute or determine other driving metrics, such as the indicator or number of instances of crossing lane lines 406 and/or the indicator of a number of instances of running red lights.

In some implementations, the autonomy computing system 200, the behaviors and planning module 238 and/or the driving-style estimator can determine the driving style of the road actor 404 using the driving-metrics vector or the driving profile of the road actor 404. For example, the driving-style estimator can compare the driving profile of the road actor 404 to one or more reference driving profiles and determine the driving style of the road actor based on the comparison of the driving profile of the road actor 404 to the one or more reference driving profiles. Various driving styles can be defined, e.g., “normal”, “risky” and “dangerous”, and the driving-style estimator can use a separate reference driving profile or a reference driving-metrics vector for each defined driving style. Each reference driving profile can include reference driving metrics of the corresponding defined driving style. Comparing the driving profile of the road actor 404 to the reference driving profile(s) can include the autonomy computing system 200, the behaviors and planning module 238 and/or the driving-style estimator computing, for each reference driving profile a corresponding Euclidian distance, or some other distance, between the reference driving profile and the driving profile of the road actor 404. The autonomy computing system 200, the behaviors and planning module 238 and/or the driving-style estimator can determine the driving style of the road actor 404 to be equal to the defined driving style associated with reference driving profile that is closest, e.g., with the smallest distance, to the driving profile of the road actor.

In some implementations, the driving-style estimator can include a classifier. The autonomy computing system 200 and/or the behaviors and planning module 238 can provide the driving profile of the road actor 404 as input to the classifier and in response the classifier can output an indication of the estimated driving style of the road actor 404. The classifier can include or can be a multiclass classifier, Naïve Bayes classifier, support vector machine (SVM) classifier, K-nearest neighbors (KNN) classifier, a random forest classifier and/or a gradient boosting classifier, among other possible types of classifiers.

In some implementations, the driving-style estimator can include a trained learning model to estimate the driving style of each road actor 404 in the surrounding of the ego vehicle 100. The machine learning model can include a neural network, a deep learning neural network, a classifier and/or a statistical model. The machine learning model can be trained using labeled real data. In some implementations, the machine learning model can be configured to receive the kinematic parameters and the relative kinematic parameters (with respect to other road actors 404 and road features) of the road actor 404 as input and provide an indication of the estimated driving style of the road actor 404 as output. The machine learning model can be configured to receive other contextual information as input, such as information indicative of applicable road signs or corresponding traffic rules or regulations, traffic lights if any, weather conditions and/or road conditions. The autonomy computing system 200 and/or the behaviors and planning module 238 can provide the kinematic parameters of the road actor 404, the relative kinematic parameters (with respect to other road actors 404 and road features) of the road actor 404 and/or other contextual information 404 as input to the trained machine learning model and receive an indication of the estimated driving style of the road actor 404 from the trained machine learning model.

In some implementations, the trained machine learning model can be configured to receive a driving-metrics vector or driving profile of the road actor 404 as input and provide an indication of the estimated driving style of the road actor 404 as output. The autonomy computing system 200 and/or the behaviors and planning module 238 can compute or determine the driving profile of the road actor 404 using the sensor data and/or other contextual information, and provide the driving profile of the road actor as input to the trained machine learning model. In response, the trained machine learning model can provide an indication of the estimated driving style of the road actor 404 as output.

Regardless of the type of driving-style estimator used, the autonomy computing system 200 and/or the behaviors and planning module 238 can obtain information indicative of at least one of a road condition or weather condition and determine the driving style of the road actor 404 further based on the information indicative of the at least one of the road condition or weather condition. Road conditions and/or weather conditions can affect the expected speed limit and/or other expected driving behaviors. For example, in a road work area, the road actors 404 and the ego vehicle 100 are expected to slow down and be more cautious. Furthermore, in snowy or foggy weather conditions, the road actors 404 and the ego vehicle 100 are expected to slow down, avoid overtaking or changing lanes and be more cautious. Also, contextual information indicative of a road accident ahead can imply that the road actors 404 and the ego vehicle 100 are expected to slow down and change lanes to move away from the lane(s) where the accident occurs. The autonomy computing system 200 and/or the behaviors and planning module 238 can use the contextual information to determine whether the road actor 404 violated any traffic rules or regulations or any expected safe driving practices.

The method 500 include, at 508, the autonomy computing system 200 and/or the behaviors and planning module 238 determining one or more actions to be taken by the ego vehicle 100 based on the driving style of the road actor 404. In some implementations, the one or more actions to be taken by the ego vehicle 100 can depend on the relative position of the road actor 404 with respect to the ego vehicle 100. A road actor 404 can be in front or ahead of (possibly with other actors in between) the ego vehicle 100, e.g., road actor 404a, behind (possibly with other actors in between) the ego vehicle 100, such as road actor 404e, or positioned lateral (possibly with other actors in between) to the ego vehicle 100 such as road actors 404b, 404c and 404d. The one or more actions to be taken by the ego vehicle 100 can include at least one of reducing vehicle speed, changing lanes, pulling into a road shoulder, increasing speed, and/or overtaking a road actor ahead, among other possible actions.

For example, if road actor 404a that is in front or ahead of the ego vehicle 100 is determined to be driving very slow, the autonomy computing system 200 and/or the behaviors and planning module 238 can determine to cause the ego vehicle to increase speed and overtake the road actor 404a. If a road actor 404 is determined to be exhibiting a risky driving style, the autonomy computing system 200 and/or the behaviors and planning module 238 can decide or determine to cause the ego vehicle 100 to slow down in a safe manner. If the road actor 404 exhibiting the risky driving style is not in the rightmost lane, the autonomy computing system 200 and/or the behaviors and planning module 238 can cause the ego vehicle 100 to move into the rightmost lane and slow down until the road actor 404 with risky driving style is at a location where the road actor is separated from the ego vehicle 100 by a distance sufficient to limit risk to the ego vehicle 100. If a road actor 404 is determined to be exhibiting a dangerous driving style, the autonomy computing system 200 and/or the behaviors and planning module 238 can cause the ego vehicle 100 to pull into a road shoulder, if safe or possible, or into a parking area. When pulling into the road shoulder or parking place, the autonomy computing system 200 and/or the behaviors and planning module 238 can cause the ego vehicle 100 to navigate in a manner that causes the ego vehicle 100 to stay as far as possible from the road actor 404 exhibiting the dangerous driving style. If a road actor 404 is determined to be a tailgater, the autonomy computing system 200 and/or the behaviors and planning module 238 can cause the go vehicle 100 to change lanes if the tailgater is behind the ego vehicle 100. If the tailgater is ahead of or positioned lateral to the ego vehicle 100, the autonomy computing system 200 and/or the behaviors and planning module 238 can the ego vehicle 100 to maintain a speed that keeps the ego vehicle 100 at a suitable safe following distance behind the road actor 404.

The autonomy computing system 200 and/or the behaviors and planning module 238 can include or can have access to one or more data structures that map each scenario, e.g., defined by the driving style and relative position of the road actor 404 with respect to the ego vehicle 100, with the action(s) to be taken. In some implementations, the autonomy computing system 200 and/or the behaviors and planning module 238 can include a trained machine learning model that is configured to receive the driving styles and relative positions of the road actors 404 as input, and provide the action(s) to be taken as output. It is to be noted that multiple road actors 404 in the surrounding of the ego vehicle 100 can be exhibiting risky, dangerous and/or unsafe driving styles. The autonomy computing system 200 and/or the behaviors and planning module 238 can determine the one or more actions to be taken based on the driving styles and positions of the road actors in the surrounding of the ego vehicle 100. In other words, the autonomy computing system 200 can determine the relative kinematic parameters for each road actor in the surrounding of the ego vehicle 100 and determine the driving style for each of the road actors.

In some implementations, the methods described herein can be implemented by a system integrated onboard the vehicle. In some implementations, the methods described herein can be implemented by a system remote from the vehicle. For example, the system can be implemented in the cloud and can receive sensor measurements from vehicle sensors via a telecommunication network.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A system for monitoring road actors, the system comprising:
one or more sensors of a vehicle to detect and track a plurality of road actors in a surrounding of the vehicle;
a processing device in communication with the one or more sensors, the processing device is configured to execute instructions stored in a memory to perform operations comprising:
receive, from the one or more sensors, sensor data indicative of kinematic parameters of the plurality of road actors;
determine, using the sensor data, relative kinematic parameters of a first road actor of the plurality of road actors relative to other road actors and relative to one or more road features;
determine, using the kinematic parameters and the relative kinematic parameters of the first road actor, a driving style of the first road actor; and
determine one or more actions to be taken by the vehicle based on the driving style of the first road actor.

2. The system of claim 1, wherein the kinematic parameters of the plurality of road actors include at least one of:
a velocity for each road actor of the plurality of road actors;
a yaw turning rate for each road actor of the plurality of road actors;
an acceleration of each road actor of the plurality of road actors; or
a relative position of each road actor with respect to the vehicle.

3. The system of claim 1, wherein the one or more relative kinematic parameters of the first road actor include at least one of:
a relative velocity of the first road actor compared to a velocity of a second road actor of the plurality of road actors;
a relative acceleration of the first road actor compared to an acceleration of the second road actor;
a relative position of the first road actor with respect to the second road actor; or
a relative position of the first road actor compared to one or more lane lines.

4. The system of claim 1, wherein the processing device is configured to:
repeat determining the kinematic parameters and relative kinematic parameters of the first road actor over a time period; and
determine the driving style of the first actor using the kinematic parameters and relative kinematic parameters of the first road actor determined over the time period.

5. The system of claim 4, wherein the processing device is configured to:
determine, using the kinematic parameters and relative kinematic parameters of the first road actor determined over the time period, a plurality of metrics indicative of driving behaviors of the first road actor; and
determine the driving style of the first road actor using the plurality of metrics.

6. The system of claim 5, wherein the plurality of metrics include at least one of:
an average distance between the first road actor and a second road actor in front of the first road actor;
an average distance between the first road actor and a lateral road actor;
an average jerk value;
an average delay in deceleration response;
a number of lane-line crossings; or
violations of driving rules over the time period.

7. The system of claim 1, wherein the processing device is configured to:
generate, using the kinematic parameters and the relative kinematic parameters of the first road actor, a driving profile of the first road actor including a plurality of metrics indicative of driving behaviors of the first road actor;
compare the driving profile of the first road actor to one or more reference driving profiles; and
determine the driving style of the first road actor based on the comparison of the driving profile of the first road actor to the one or more reference driving profiles.

8. The system of claim 1, wherein the processing device is configured to:
generate, using the kinematic parameters and the relative kinematic parameters of the first road actor, a driving profile of the first road actor including a plurality of metrics indicative of driving behaviors of the first road actor; and
determine the driving style of the first road actor by providing the driving profile of the first road actor as input to a trained machine learning model, the trained machine learning model providing the driving style of the first road actor as output responsive to receiving the driving profile of the first road actor as input.

9. The system of claim 1, wherein the processing device is configured to:
obtain information indicative of at least one of a road condition or weather condition; and
determine the driving style of the first actor further based on the information indicative of the at least one of the road condition or weather condition.

10. The system of claim 1, wherein the one or more actions to be taken by the vehicle depend on the relative position of the first road actor with respect to the vehicle, the one or more actions including at least one of:
reduce vehicle speed;
change lanes; or
pull into a road shoulder.

11. A method for monitoring road actors, the method comprising:
receiving, from one or more sensors of a vehicle, sensor data indicative of kinematic parameters of a plurality of road actors in a surrounding of the vehicle;
determining, using the sensor data, relative kinematic parameters of a first road actor of the plurality of road actors relative to other road actors and relative to one or more road features;
determining, using the kinematic parameters and the relative kinematic parameters of the first actor, a driving style of the first road actor; and
determining one or more actions to be taken by the vehicle based on the driving style of the first road actor.

12. The method of claim 11, wherein the kinematic parameters of the plurality of road actors include at least one of:
a velocity for each road actor of the plurality of road actors;
a yaw tuning rate for each road actor of the plurality of road actors;
an acceleration of each road actor of the plurality of road actors; or
a relative position of each road actor with respect to the vehicle.

13. The method of claim 11, wherein the one or more relative kinematic parameters of the first road actor include at least one of:
a relative velocity of the first road actor compared to a velocity of a second road actor of the plurality of road actors;
a relative acceleration of the first road actor compared to an acceleration of the second road actor;
a relative position of the first road actor with respect to the second road actor; or
a relative position of the first road actor compared to one or more lane lines.

14. The method of claim 11, comprising:
repeating determining the kinematic parameters and relative kinematic parameters of the first road actor over a time period; and
determining the driving style of the first road actor using the kinematic parameters and relative kinematic parameters of the first road actor determined over the time period.

15. The method of claim 14, comprising:
determining, using the kinematic parameters and relative kinematic parameters of the first road actor determined over the time period, a plurality of metrics indicative of driving behaviors of the first road actor; and
determining the driving style of the first road actor using the plurality of metrics.

16. The method of claim 15, wherein the plurality of metrics include at least one of:
an average distance between the first road actor and a second road actor in front of the first actor;
an average distance between the first road actor and a lateral road actor;
an average jerk value;
an average delay in deceleration response;
a number of lane-line crossings; or
violations of driving rules over the time period.

17. The method of claim 11, comprising:
generating, using the kinematic parameters and the relative kinematic parameters of the first road actor, a driving profile of the first road actor including a plurality of metrics indicative of driving behaviors of the first road actor;
comparing the driving profile of the first road actor to one or more reference driving profiles; and
determining the driving style of the first road actor based on the comparison of the driving profile of the first road actor to the one or more reference driving profiles.

18. The method of claim 11, comprising:
generating, using the kinematic parameters and the relative kinematic parameters of the first road actor, a driving profile of the road first actor including a plurality of metrics indicative of driving behaviors of the first road actor; and
determining the driving style of the first road actor by providing the driving profile of the first road actor as input to a trained machine learning model, the trained machine learning model providing the driving style of the first road actor as output responsive to receiving the driving profile of the first road actor as input.

19. The method of claim 11, comprising:
obtaining information indicative of at least one of a road condition or weather condition; and
determining the driving style of the first actor further based on the information indicative of the at least one of the road condition or weather condition.

20. The method of claim 11, wherein the one or more actions to be taken by the vehicle depend on the relative position of the first road actor with respect to the vehicle, the one or more actions including at least one of”
reduce vehicle speed;
change lanes; or
pull into a road shoulder.
